(19) United States
(12) Patent Application Publication
(10) Pub. No.: US 2017/0052530 A1
(43) Pub. Date: Feb. 23, 2017

(54) TOOL HAVING PREVENTATIVE FRACTURE, BREAKAGE, CRACK AND WEAR DETECTION

(71) Applicant: CERAMTEC GMBH, Plochingen (DE)

(72) Inventors: Jose AGUSTIN-PAYA, Mulheim an der Ruhr (DE); Hans-Jurgen SCHREINER, Hersbruck (DE); Reiner BINDIG, Bindlach (DE)

(21) Appl. No.: 15/101,793

(22) PCT Filed: Dec. 3, 2014
(86) PCT No.: PCT/EP2014/076407

§ 371 Date: Nov. 4, 2016

(30) Foreign Application Priority Data
Dec. 4, 2013 (DE) 102013224906.3

(51) Int. Cl. G05B 19/4065; B23Q 17/09

(52) U.S. Cl. CPC G05B 19/4065; B23Q 17/0966; B23Q 17/0957; G05B 2219/37344; G05B 2219/50205; G05B 2219/50203

(57) ABSTRACT

The invention relates to a method for monitoring a machining tool that is used for machining primarily metal materials, comprising a cutting tool, wherein the cutting force, feed force, and passive force can be adjusted during machining, and comprising sensors to measure forces. In order that machining can be stopped 2 to 60 seconds, preferably 2 to 10 seconds, prior to failure of the cutting body, the invention proposes that the sensors continuously sense at least one of said forces during machining and machining is stopped if a sudden reduction in the sensed force occurs.

The invention relates to a method for monitoring a machining tool that is used for machining primarily metal materials, comprising a cutting tool, wherein the cutting force, feed force, and passive force can be adjusted during machining, and comprising sensors to measure the forces.

The machining tool includes a receiving opening with seating walls to receive a cutting body, the cutting body being anchored by fastening means. The fastening means are screws, wedges, or clamping claws that pull the cutting body into the receiving opening such that the cutting body rests against the seating walls. However, the cutting body can also be attached to a base body by, such as e.g., soldering, gluing, or similar permanent attachment means.

The cutting tips, usually indexable cutter inserts, are preferably composed of ceramic or CBN-based materials. CBN refers to cubic boron nitride. It is also possible to use other hard materials.

The cutting edge wears down with use for machining after a certain period of time. After a predefined tool life, i.e., amount of machining time, is reached, the cutting body is changed, or the machining is continued using another cutting edge of the cutting body until all available cutting edges are worn out. A dangerous situation arises if the cutting body breaks during machining, and individual parts are thrown outward at extremely high speeds or even pressed into the component being machined. This can result in the destruction of the workpiece or the machining tool. The object is to prevent this situation.

EP 1 984 142 B1 discloses an approach whereby piezoceramic sensors are used to measure the compressive, tensile, or shear forces acting on the cutting body or retainer, and to control machining so as to prevent damage from overloading. Limit values are set for the forces such that an intervention is effected whenever these values are exceeded. The disadvantage here is that machining is very often stopped too early, since the limit values are set within a higher-than-negligible safety margin so as to preclude any damage in all situations.

The invention describes a tool having preventative fracture, breakage, crack and wear detection. The object of the invention is to improve a method as set forth in the preamble of Claim 1 whereby machining is stopped 2 to 60 seconds, preferably, 2 to 10 seconds, before the cutting body fails.

This object is achieved according to the invention by a method as set forth in Claim 1.

An approach is provided whereby the sensors continuously sense at least one of the referenced forces during machining, and machining is stopped immediately before any failure of the cutting body in response to a sudden reduction of the sensed force.

Previous cutting tests have shown that a sudden reduction in forces occurs a specific time before the cutting edge or the cutting body breaks. The structure of the cutting body seems to suffer fatigue shortly before fracture, and this becomes detectable by a weakening and thus reduction in the forces.

This “sharp bend” in the force curve occurs every time and reliably, with the result that this “sharp bend” can be considered a signal that occurs shortly before the cutting body fractures. Machining must be interrupted immediately as soon as this occurs, and another cutting edge or cutting body must be used.

This signal can be detected in all 3 force components, i.e., for the cutting force, the feed force, and the passive force.

The preferred sensors used here are piezoelectric force transducers or structure-borne sound sensors. In terms of pricing, structure-borne sound sensors are cheaper than piezoelectric force transducers. Piezoelectric force transducers are extremely reliable and advantageous in terms of the precision of measurement.

The evaluation of the force signals is preferably effected at a frequency of 1 Hz to approximately 1 MHz, especially preferably at a frequency of 100 Hz to 100 kHz. The best results were achieved in these frequency ranges.

The measured voltage signals are preferably evaluated by a charge amplifier.

The machining can be static =turning, grooving, profiling, broaching, or correspondingly analogous processes. However, the machining tool can also be rotary =milling, drilling, reaming, rough drilling, or correspondingly analogous processes.

The machining tool can be designed with either a replaceable cutting edge, also called an indexable cutter insert, and/or a mono-tool (solid-material tool). The mono-tool can be composed entirely of one material or of multiple materials that are joined, such as e.g. soldered together.

The cutting part of the tool can be composed of a variety of cutting materials, such as e.g. hard metal, cermet, ceramic, CBN, PKD, or any cutting materials developed in the future, and additionally using either uncoated and/or coated designs.

A principal goal achieved by the preventative detection of tool failure is reducing reject-associated costs, and fabrication and process costs in general for users in an extremely wide variety of industries (e.g., the automotive industry, aerospace industry, mold and die construction, general mechanical engineering, roller bearing industry, etc.).

In order to achieve this goal, sensors are inserted in the relevant tool, which sensors record load factors and convert these to signals during the machining process. During the machining process, the characteristic signal indicating the imminent failure of the cutting edge is extracted by filtering from the multiplicity of signals, and used as the warning signal. The referenced warning signal enables the machine tool to be switched off and/or use of a so-called twin tool (replacement tool) to be effected. The warning signal can also be used, however, for a wide range of purposes.

The tool can furthermore transmit the warning signal by means of a cable connection with the control unit, however, preferably by wireless means. This can be effected using various radio technologies.

Filtering of the warning signals can be implemented in such a way that the usage parameters of the process or other limiting parameters indirectly or directly involved in the process do not play any role. (E.g., cutting speed, cutting depth, feed rate, use or non-use of cooling lubricant, high-pressure cooling, flying chips, vibrations, etc.)

The machine tool system can be employed either as a system that is integrated in a machine tool or independently. Analysis of the general cutting action of the machining tools can also be considered a secondary application of the tool system.

The invention also relates to a sensor-type tool in general.
a) The tool can, for example, include piezoelectric force transducers that separately sense the various force components.
b) The evaluation of the force signals is effected from 1 Hz to approximately 1 MHz, preferably in the range of 100 Hz-100 kHz.
c) The generated voltage signals are evaluated by a charge amplifier.
   The installed sensors record the cutting forces during the cutting process.
   In response, forces and vibration signals are generated by a corresponding electronic equipment setup.
   The purpose of the signal/data analysis is to extract by filtering or identify from the multiplicity of signals one signal that is characteristic and is found to be always essentially the same value; as a result, this signal may be recognized as the relevant one, based on which any subsequent damage to the cutting edge can be prevented early on before the damage occurs.
   The primary goal is to equip tools with replaceable cutting inserts, said tools being intended for machining by turning and grooving (also called static tools) as well as those lacking replaceable cutting bodies (static and rotary, also called mono-tools).
      However, it is also possible and is also the object of this application to equip rotary tools having multiple cutting inserts (milling cutters, drills, countersinks, etc.).
         Machining always involves 3 force components (cutting force, feed force, and passive force). These force components are sensed by the sensor during the working process and continuously stored. Vibrations are also an important factor, and these vibrations are also sensed.

1. Method for monitoring a machining tool that is used for machining primarily metal materials, comprising a cutting tool, wherein the cutting force, feed force, and passive force can be adjusted during machining, and comprising sensors to measure forces, characterized in that the sensors continuously sense at least one of the forces during machining and stop the machining process whenever a sudden reduction in the sensed force occurs.

2. Method according to claim 1, characterized in that piezoelectric force transducers or structure-borne sound sensors are used as the sensors.

3. Method according to claim 1, characterized in that evaluation of the force signals is effected at a frequency of 1 Hz to approximately 1 MHz, preferably at a frequency of 100 Hz to 100 kHz.

4. Method according to claim 1, characterized in that the measured voltage signals are evaluated by a charge amplifier.

5. Method according to claim 2, characterized in that evaluation of the force signals is effected at a frequency of 1 Hz to approximately 1 MHz, preferably at a frequency of 100 Hz to 100 kHz.

6. Method according to claim 2, characterized in that the measured voltage signals are evaluated by a charge amplifier.

7. Method according to claim 3, characterized in that the measured voltage signals are evaluated by a charge amplifier.
